(19) United States
(12) Patent Application Publication
(10) Pub. No.: US 2006/0126248 A1
(43) Pub. Date: Jun. 15, 2006

(54) Method and apparatus for controlling device power supply in semiconductor tester

(75) Inventors: Seung-Chul Choi, Gyeonggi-do (KR); Do-Hoon Byun, Gyeonggi-do (KR); Ki-Myung Seo, Gyeonggi-do (KR); Sang-Bae An, Gyeonggi-do (KR); Byong-Hui Yun, Gyeonggi-do (KR); Kyu-Jeong Lee, Gyeonggi-do (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/240,208

(22) Filed: Sep. 30, 2005

(30) Foreign Application Priority Data
Dec. 9, 2004 (KR) 10-2004-0103526

(51) Int. Cl. H02H 3/08

(52) U.S. Cl. 361/93.1

(57) ABSTRACT

An apparatus for testing a semiconductor device includes: a power supplying unit for generating a voltage to be supplied to the semiconductor device under control of a test controller; a voltage transmitting unit for transmitting the voltage to the semiconductor device under control of the test controller; and an overcurrent detecting unit for detecting whether an overcurrent is supplied from an output of the power supplying unit, wherein the voltage transmitting unit cuts off a voltage supply to the semiconductor device in response to an output of the overcurrent detecting unit without intervention of the test controller.

### RELATED APPLICATION

The present application claims priority from Korean Patent Application No. 2004-103526, filed Dec. 9, 2004, the disclosure of which is incorporated herein by reference in its entirety.

### FIELD OF THE INVENTION

The present invention relates to an apparatus for testing a semiconductor device, and more particularly, to a method of controlling a voltage output of a device power supply (DPS) that supplies a voltage to a device to be tested using a semiconductor tester.

### BACKGROUND OF THE INVENTION

In manufacturing semiconductor devices such as an Application Specific Integrated circuit (ASIC), a Synchronous Dynamic Random Access Memory (SDRAM) and a Static Random Access Memory (SRAM), various device characteristics and circuit reliability are tested using a die sort test after a wafer manufacturing process is ended. Then, defective products are sorted and the results are displayed. At this stage, a device power supply is used to supply a test voltage to the device to be tested. The device power supply supplies a voltage close to that of a situation when the device is in operation. Accordingly, the device power supply variably supplies the voltage to the device according to a usage requirement of the device. Then, electrical properties of the device responsive to the corresponding voltage are tested.

FIG. 1 is a schematic block diagram of a conventional semiconductor tester. Referring to the FIG. 1, the conventional semiconductor tester includes a test controller 10 configured with a personal computer or workstation, a power supplying unit 30 for supplying a voltage to a device, a relay controlling unit 20 for selectively supplying a voltage, an overcurrent detecting unit 40 for detecting an overcurrent of a supply voltage, a relay 50, and a probe card 80 for supplying a voltage to the device to be tested.

The overcurrent detecting unit 40 detects whether a current that is much larger than that outputted from a normal device occurs from a corresponding semiconductor device 60. When the overcurrent is detected, the overcurrent detecting unit 40 generates an overcurrent generation signal to the test controller 10. The test controller 10 receives the overcurrent generation signal and issues a command of cutting off the voltage to the relay controlling unit 20. Then, the relay controlling unit 20 turns off the relay 50 in response to the command.

Like this, the overcurrent generation signal from the overcurrent detecting unit 40 is retransmitted to the test controller 10, and the test controller 10 receives the overcurrent generation signal to issue the command of cutting off the voltage to the relay controlling unit 20. At this time, the overcurrent continuously flows in the power supplying unit 30 even when the overcurrent detection signal is transferred through an interface between the overcurrent detecting unit 40 and the test controller 10 and an interface between the overcurrent detecting unit 40 and the relay controlling unit 20, and even when the test controller 10 (that is, PC or workstation) performs an operation. As shown in FIG. 2, during the necessary time, a burnt phenomenon is caused by an overcurrent of a probe card tip 810 that is in contact with the device to be tested and serves as a voltage supply path. The burnt phenomenon and the overcurrent of the power supplying unit causes a breakdown and degrades efficiency of the expensive equipment, thereby increasing a manufacturing cost and lowering price competitiveness of a company.

### SUMMARY OF THE INVENTION

Embodiments of the present invention provide a method and apparatus for testing a semiconductor device.

According to embodiments of the present invention, there is provided an apparatus for testing a semiconductor device, including: a power supplying unit for generating a voltage to be supplied to the semiconductor device under control of a test controller; a voltage transmitting unit for transmitting the voltage to the semiconductor device under control of the test controller; and an overcurrent detecting unit for detecting whether an overcurrent is supplied from an output of the power supplying unit, wherein the voltage transmitting unit cuts off a voltage supply to the semiconductor device in response to an output of the overcurrent detecting unit without intervention of the test controller.

The voltage transmitting unit may include: a relay for transmitting the voltage from the power supplying unit to the semiconductor device; and a relay controlling unit for controlling a switching operation of the relay according to an output of the test controller or the output of the overcurrent detecting unit.

The relay controlling unit may control the relay in response to the output of the overcurrent detecting unit when the overcurrent is supplied from the output of the power supplying unit.

The voltage transmitting unit may further include a probe card tip for transmitting the voltage from the relay to the semiconductor device.

According to other embodiments of the present invention, there is provided a method for controlling a voltage output of an apparatus for testing a semiconductor device under control of a test controller, the method including the steps of: generating a voltage to be supplied to the semiconductor device; transferring the voltage to the semiconductor device; detecting whether an overcurrent is supplied from an output of a power supplying unit; and when the overcurrent is supplied from the output of the power supplying unit, cutting off a power supply to the semiconductor device without intervention of the test controller.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic block diagram of a conventional device power supply;

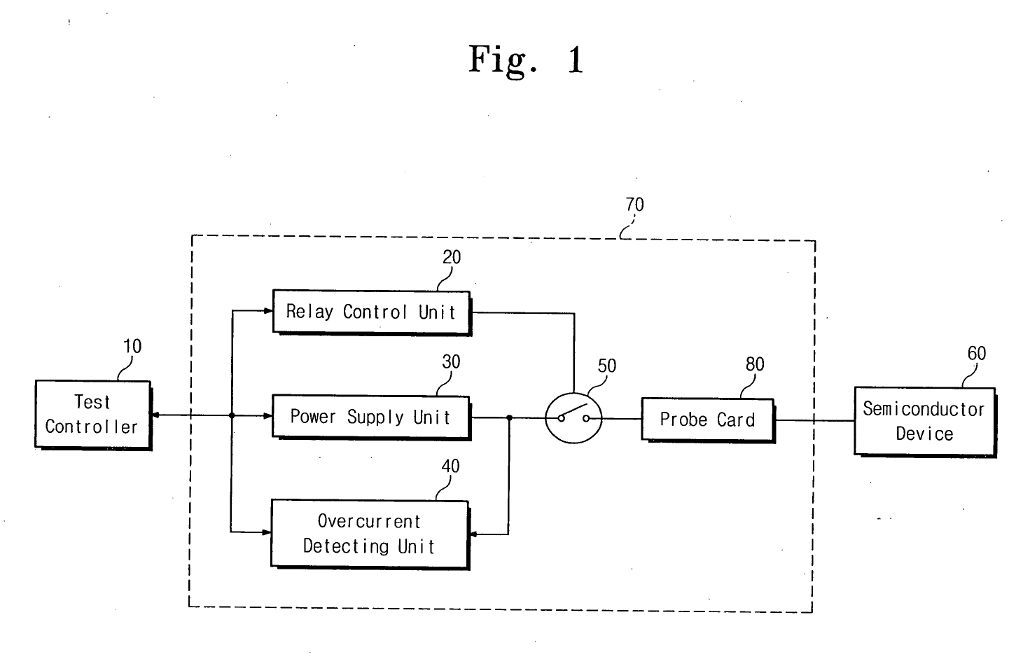

FIG. 2 is a schematic diagram illustrating a probe card tip of a conventional device power supply;

FIG. 3 is schematic block diagram of a device power supply according to an embodiment of the present invention; and

FIG. 4 is a flowchart illustrating a method for controlling the device power supply according to an embodiment of the present invention.

### DETAILED DESCRIPTION OF THE INVENTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise. All publications, patent applications, patents, and other references mentioned herein are incorporated herein by reference in their entireties.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a “first” element, component, region, layer or section discussed below could also be termed a “second” element, component, region, layer or section without departing from the teachings of the present invention. The sequence of operations (or steps) is not limited to the order presented in the claims or figures unless specifically indicated otherwise.

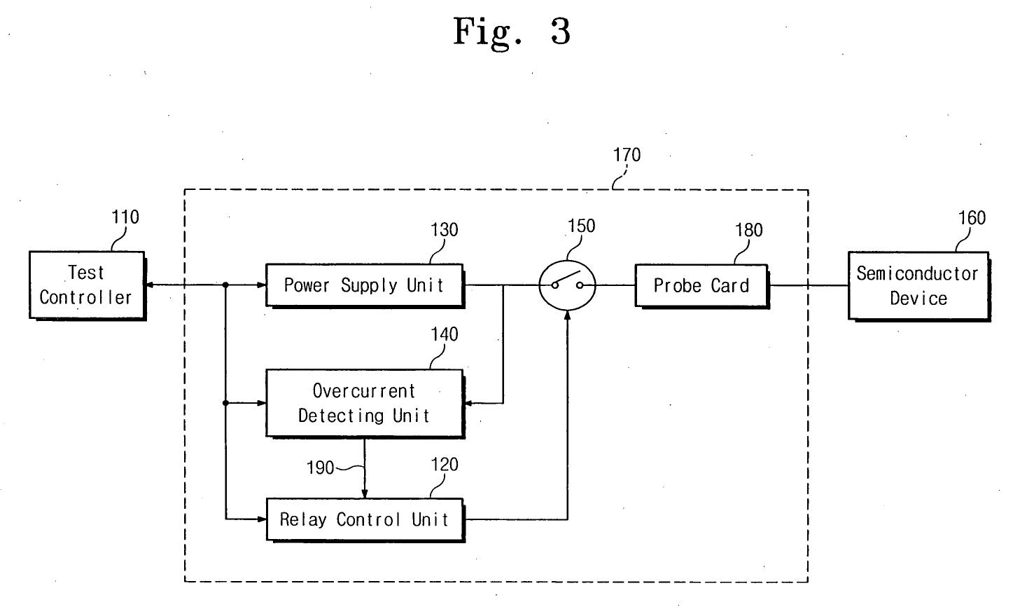

Referring to the FIG. 3, a semiconductor tester for testing a semiconductor device 160 in a wafer level includes a test controller 110 and a device power supply 170. The test controller 110 may be provided with a personal computer or a workstation and controls the device power supply 170 in a test mode. It will be apparent to those skilled in the art that various modifications and variations of the test controller 110 can be made in the present invention. The device power supply 170 is controlled by the test controller 110 and supplies a voltage to a semiconductor device 160. The device power supply 170 includes a relay controlling unit 120, a power supplying unit 130, an overcurrent detecting unit 140, a relay 150, and a probe card 180. The relay controlling unit 120, the relay 150 and the probe card 180 constitute a voltage transmitting unit for transmitting a voltage generated from the power supplying unit 130 to the semiconductor device 160.

Under control of the test controller 110, the power supplying unit 130 supplies a voltage to the semiconductor device 160. In order to artificially supply a voltage close to that experienced by the semiconductor device 160 in a mounted environment within an end-product, the device power supply 170 varies a voltage to a certain level and then supplies various levels of voltage to the semiconductor device 160 in response to a power control signal from the test controller 110. In order to correctly detect frequency characteristics and time delay characteristics of the semiconductor device 160, the semiconductor tester may include a filter circuit for eliminating noise from an applied DC voltage, and a constant voltage circuit for supplying a stable voltage regardless of load variation.

The overcurrent detecting unit 140 is electrically connected to an output terminal of the power supplying unit 130. The overcurrent detecting unit 140 compares a normal current value with an overcurrent value generated from a defective semiconductor device. When the overcurrent value is greater than the normal current value, the overcurrent detecting unit 140 generates an overcurrent generation signal. A transmission path 190 is further provided to directly transfer the overcurrent generation signal to the relay controlling unit 120 when the overcurrent is detected. In addition, an output path is provided to temporarily store the overcurrent generation signal, transmit the stored signal to the test controller 110 such that it can be used as information for marking and processing with respect to defective devices.

The relay controlling unit 120 controls an operation of the relay 150 according to a command produced from the test controller 110. In the starting and ending of a test, the relay controlling unit 120 generates, to the relay 150, an operation signal of supplying or cutting off the voltage supplied to the semiconductor device 160. The relay controlling unit 120 receives the overcurrent generation signal from the overcurrent detecting unit 140 through an appropriate input unit. Accordingly, the relay controlling unit 120 has a circuit configuration where the relay controlling unit 120 is controlled by the command of the test controller 110 and the detection result of the overcurrent detecting unit 140.

The relay 150 operates as a switch that is responsive to a relay control signal from the relay controlling unit 120 and supplies or cuts off the voltage supplied from the power supplying unit 130 to the corresponding semiconductor device 160 to be tested.

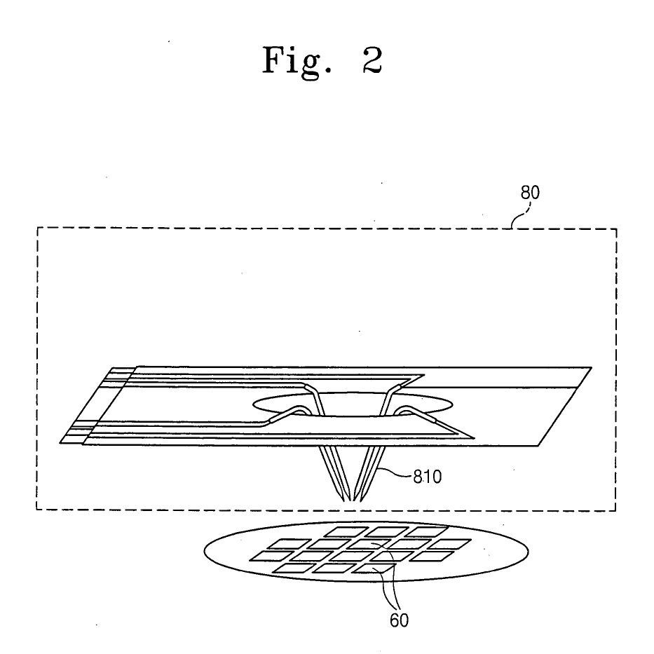

The probe card 180 supplies the test voltage generated from the power supplying unit 130 to the each semiconductor device 160 on a wafer. A probe card tip 810, for example as shown in FIG. 2, supplies an electrical signal from the power supplying unit 130 on a chip after contacting the pad of a semiconductor device to be tested. The probe card tip 810 is a key part in the probe card 180 because the probe card tip 810 plays an important role in influencing a yield of wafer depending on contact resistance, abrasion, and lifetime.

According to the illustrated circuit configuration, the relay 150 is turned off upon detecting an overcurrent without intervention by the test controller 110. As a result, it is possible to prevent a probe card tip 810 and the power supplying unit 130 from being damaged due to the overcurrent flowing through a defective device.

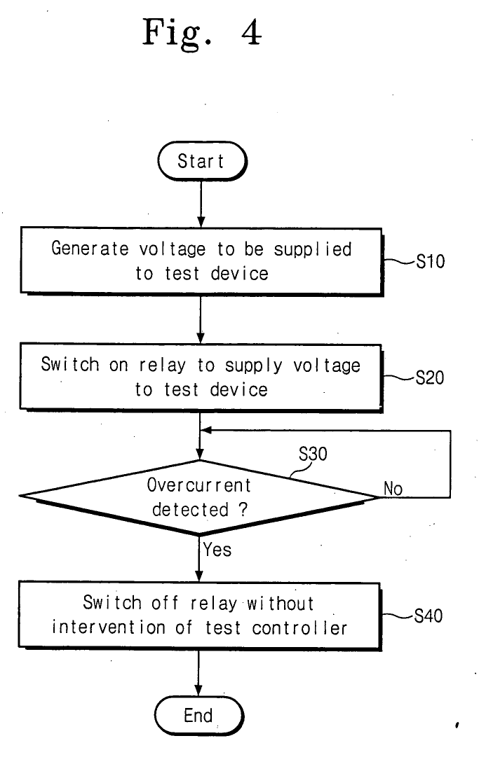

FIG. 4 is a flowchart illustrating a method for controlling the device power supply 170 of FIG. 3, according to embodiments of the present invention. When the test operation starts, the test controller 110 controls the device power supply 170 to generate a voltage and supply the voltage to the semiconductor device 160 to be tested.

The test operation begins as the test controller 110 produces a voltage supply command to the power supplying unit 130. In step S10, the power supplying unit 130 generates a test voltage to be supplied to the semiconductor device 160 to be tested in response to the voltage supply command. The test controller 110 generates a relay-on signal to the relay controlling unit 120 and the relay controlling unit 120 switches on the relay 150 in response to the relay-on signal. Accordingly, the test voltage generated by the power supplying unit 130 is supplied to the semiconductor device 160 through the switched-on relay 150 and the probe card 180. Under this condition, voltage and frequency characteristics of the semiconductor device 160 are tested.

In step S30, during the test operation, the overcurrent detecting unit 140 detects whether an overcurrent flows from an output terminal of the power supplying unit 130. An overcurrent flows when a semiconductor device 160 is defective. The overcurrent detecting unit 140 detects the overcurrent and transfers an overcurrent generation signal to both the test controller 110 and the relay controlling unit 120. In step S40, the relay controlling unit 120 switches off the relay 150 without intervention of the test controller 110 in response to the overcurrent generate signal. The power supplying unit 130 cuts off the voltage supplied to a defective semiconductor device 160. Moreover, the test controller 110 receiving the overcurrent generate signal from the overcurrent detecting unit 140 classifies the tested semiconductor device 160 as a defective one after switching off the relay 150. After these steps, the probe card 80 moves on to the next semiconductor device and then the same test operation is performed thereon.

When an overcurrent occurs due to a defective semiconductor device, the voltage supplied to the semiconductor device is cut off by the relay 50 with direct control of the relay controlling unit 120 without passing through the test controller 110 in the device power supply 170. Compared with conventional methodologies, the detection/determination operation of the overcurrent and the operation such as the execution of the relay switching-off are omitted. Therefore, the probe card tip 810 and the power supplying unit 130 can be promptly protected from an overcurrent.

As mentioned above, the present invention can reduce testing time and can cut off an overcurrent more promptly to thereby protect expensive semiconductor test equipment without intervention of a test controller when detecting the overcurrent.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. The invention is defined by the following claims, with equivalents of the claims to be included therein.

What is claimed is:

1. An apparatus for testing a semiconductor device, the apparatus comprising:
a power supplying unit that generates a voltage to be supplied to a semiconductor device, wherein the semiconductor device is under control of a test controller;
a voltage transmitting unit that transmits the generated voltage to the semiconductor device; and
an overcurrent detecting unit that detects whether an overcurrent is supplied from an output of the power supplying unit,
wherein the voltage transmitting unit cuts off a voltage supply to the semiconductor device in response to an output of the overcurrent detecting unit without intervention by the test controller.

2. The apparatus of claim 1, wherein the voltage transmitting unit comprises:
a relay that transmits the voltage from the power supplying unit to the semiconductor device; and
a relay controlling unit that controls a switching operation of the relay according to an output of the test controller or the output of the overcurrent detecting unit.

3. The apparatus of claim 2, wherein the relay controlling unit controls the relay in response to the output of the overcurrent detecting unit when the overcurrent is supplied from the output of the power supplying unit.

4. The apparatus of claim 2, wherein the voltage transmitting unit further comprises a probe card tip that transmits the voltage from the relay to the semiconductor device.

5. A method for controlling a voltage output of an apparatus for testing a semiconductor device under control of a test controller, comprising the steps of:
generating a voltage to be supplied to the semiconductor device;
transferring the voltage to the semiconductor device;
detecting whether an overcurrent is supplied from an output of a power supplying unit; and
cutting off a power supply to the semiconductor device without intervention by the test controller when an overcurrent is supplied from the output of the power supplying unit.

6. The apparatus of claim 2, further comprising a transmission path directly between the overcurrent detecting unit and the relay controlling unit.
